(19) United States
(12) Patent Application Publication
(10) Pub. No.: US 2016/0357916 A1
(43) Pub. Date: Dec. 8, 2016

(54) SYSTEM AND METHOD FOR MANAGING PATIENT CONSENT

(71) Applicant: Humana Inc., Louisville, KY (US)

(72) Inventors: Mark Willard, San Jose, CA (US); George Morris, Los Gatos, CA (US)

(21) Appl. No.: 14/491,427

(22) Filed: Sep. 19, 2014

Related U.S. Application Data
(63) Continuation-in-part of application No. 13/587,728, filed on Aug. 16, 2012.
Application No. 13/587,728 is a continuation-in-part of application No. 12/893,384, filed on Sep. 29, 2010.
(60) Provisional application No. 62/002,549, filed on May 23, 2014.

(51) Int. Cl. G06F 19/00; G06F 21/62

(52) U.S. Cl. CPC G06F 19/322; G06F 21/6245

(57) ABSTRACT

A computerized system and method for managing patient consent and for customizing patient consent policies is disclosed. The computerized system and method comprises a medical information exchange consent policy module that further includes instructions executed by a processor to supply to a patient with a medical information exchange consent policy interface with selectable medical information exchange consent policy elements. An electronic medical record (EMR) appliance receives selected medical information exchange consent policy elements from the user, accepts from an electronic medical record system a medical record request for the patient, filters the complete medical record for the patient in accordance with the selected medical information exchange consent policy elements to form a consent-filtered medical record and transfers the consent-filtered medical record to the electronic medical record system. Consent policies may be defined within a practice to control which portions of the medical record, if any, should be redacted.

### CROSS-REFERENCE TO RELATED APPLICATIONS

This application claims priority to U.S. Provisional Application Ser. No. 62/002,549, filed May 23, 2014 and titled SYSTEM AND METHOD FOR MANAGING PATIENT CONSENT and to U.S. application Ser. No. 13/587,728, filed Aug. 16, 2012 and titled APPARATUS AND METHOD FOR MEDICAL INFORMATION EXCHANGE CONSENT POLICY DATA FILTERING, the contents of each of which are incorporated herein by reference.

### BACKGROUND

The Health Insurance Portability and Accountability Act (HIPAA) Privacy Rule regulates the use and disclosure of Protected Health Information (PHI) held by healthcare providers, health plans and insurers, and other health and medical service entities. PHI covers health status and condition information as well as payment and other health-related information that can be linked to an individual. The Privacy Rule requires entities that provide health and medical-related services to notify individuals of the uses. Entities are also required to track disclosures of PHI and to document their privacy policies and procedures. To ensure that individuals are aware of PHI uses, healthcare systems typically require patients to sign a patient consent form that discloses PHI uses consistent with HIPAA as well other policies adopted by the healthcare system.

Within a large healthcare system, patient consent policies can vary by state, region, or even by hospital facility based on the information that is collected and how it is used or shared. Healthcare systems typically attempt to manage this process by convening a governing board that attempts to incorporate all policies into a single set. Besides the large effort and time needed to align these policies, the resulting policies may not meet the requirements of the various providers within the system. Furthermore, individual patients within a system may be confused by the policies and may not understand how they are applied to their PHI. There is a need for a computerized system and method for managing patient consent and for supporting customization of consent policies to meet the needs of providers and patients.

### SUMMARY

The present disclosure is directed to a computerized system and method for managing patient consent and for customizing patient consent policies. The computerized system and method comprises an electronic medical record (EMR) appliance or apparatus that facilitates the exchange of information between electronic medical record systems that store complete medical records for patients. The electronic medical record systems may be incompatible with one another. They often have different user interfaces and may store data in disparate records. The EMR appliance receives requests for stored patient data, connects to one or more electronic medical record systems, retrieves and normalizes the requested data, and transmits it for presentation to a healthcare provider user.

The EMR appliance includes a medical information exchange consent policy module that further includes instructions executed by a processor to supply to a patient with a medical information exchange consent policy interface with selectable medical information exchange consent policy elements. The EMR appliance receives selected medical information exchange consent policy elements from the user, accepts from an electronic medical record system a medical record request for the patient, filters the complete medical record for the patient in accordance with the selected medical information exchange consent policy elements to form a consent-filtered medical record and transfers the consent-filtered medical record to the electronic medical record system.

A computerized method includes storing a complete medical record for a patient, supplying to the patient a medical information exchange consent policy interface with selectable medical information exchange consent policy elements, receiving selected medical information exchange consent policy elements from the patient, accepting a medical record request for the patient, filtering the complete medical record for the patient in accordance with the selected medical information exchange consent policy elements to form a consent-filtered medical record and transferring the consent-filtered medical record.

Multiple EMR appliances may be connected to create networks and to distribute consent policy management to local healthcare provider offices. The distribution and customization of policies at the local level enforces consent at the edges and removes the need for a single, global consent policy within a large healthcare system. Consent policies may be defined within a practice with specific rules about which criteria to use in searching a health record and then additionally, which portions of the health record should be redacted (if any). This result is accomplished with a point and click interface.

### BRIEF DESCRIPTION OF THE DRAWINGS

FIG. 1 illustrates an electronic medical record (EMR) exchange system with EMR appliances;

FIG. 2 illustrates processing operations of a consent policy module for an example embodiment of the invention;

FIG. 3 illustrates an exemplary medical information exchange consent policy user interface;

FIGS. 4A and 4B illustrate a patient policy selection interface for an example embodiment of the invention; and

FIGS. 5A-5C illustrate a patient policy selection interface for a patient view embodiment of the invention.

### DETAILED DESCRIPTION

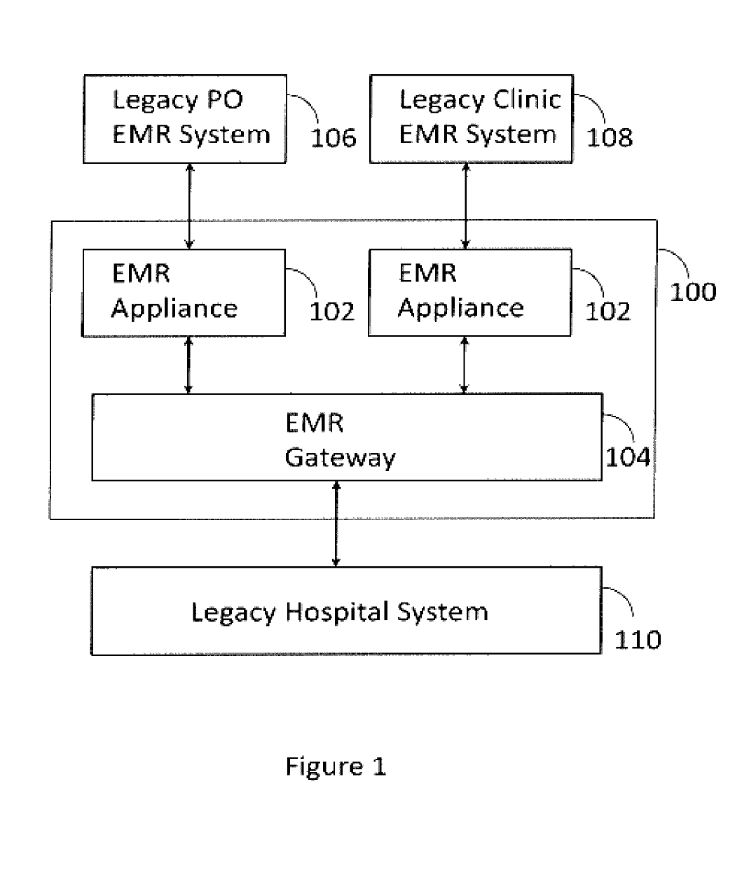

FIG. 1 illustrates an electronic medical record (EMR) exchange system 100 with EMR appliances. The system 100 includes a set of EMR appliances 102. Each EMR appliance 102 is a hardware platform designed to provide an EMR computing resource. An appliance is a closed and sealed system that is not serviceable by a user. Thus, it stands in contrast to a general purpose computer, where a user can modify the hardware configuration and load any type of software desired. An appliance has a limited interface, usually a terminal console or web-based, to allow limited configuration operations. Automated back-up, software control and maintenance are performed remotely, reducing problems related to software installation, conflicts, and updates. The EMR appliance 102 also provides protection from viruses, hackers or other threats to security. Thus, the EMR appliance reduces initial capital costs and ongoing maintenance costs.

Each EMR appliance 102 is connected to an EMR gateway server 104. The EMR gateway server 104 is a general purpose computer implementing operations for the EMR appliances. The EMR appliances 102 and EMR gateway server 104 operate as an EMR exchange system 100 to provide interoperability with legacy EMR systems. For example, a first EMR appliance may be connected to a legacy physician's office EMR system 106, while another EMR appliance 102 may be connected to a legacy medical clinic EMR system 108. The EMR gateway server 104 may be connected to a legacy hospital EMR system. In general, an EMR appliance 102 is used in connection with a relatively small legacy EMR system, while an EMR gateway 104 is used in connection with a relatively large legacy EMR system. The system 100 may be configured with additional EMR appliances and EMR gateways 104.

The EMR appliances comprise a medical information exchange consent policy module that further includes instructions executed by a processor to supply to a patient with a medical information exchange consent policy interface with selectable medical information exchange consent policy elements. In an example embodiment, a patient is presented with a choice of consent policies from which to select. The patient's choice is received at the medical information exchange consent policy module. From that point forward, only the information appropriate to that policy is shown or shared with other entities within a healthcare system. For example, a patient at a mental health clinic may not want diagnosis or medication data to be shared with a family physician at a home family practice. The mental health clinic creates a policy that includes a “Don't share mental health diagnosis” element to indicate which codes should be considered mental health codes. The policy further indicates these codes should be removed along with the Problems and Medications sections of the Clinical Document Architecture (CDA) medical record.

When the family physician logs into his EMR appliance and views an integrated patient record, he sees local data and also the data from the connected EMR appliance at the Mental Health clinic but with the Problems and Medications sections along with the specific mental health codes redacted. With this approach, the consent policy is enforced at the local EMR appliance and the family physician sees only the PHI the patient has agreed to share. By contrast, some prior art systems send an entire information set and the policy to the recipient assuming the recipient will apply the policy correctly. The recipient may then inadvertently share the data without the related consent policy or may share the data with another system that does not understand what the policy means or how the rules should be applied. By implementing a solution in an EMR appliance at the local level, the necessary information is redacted so it can be shared as needed. This approach allows for a much more flexible, quickly deployed consent policy with higher security due to local enforcement of the policy.

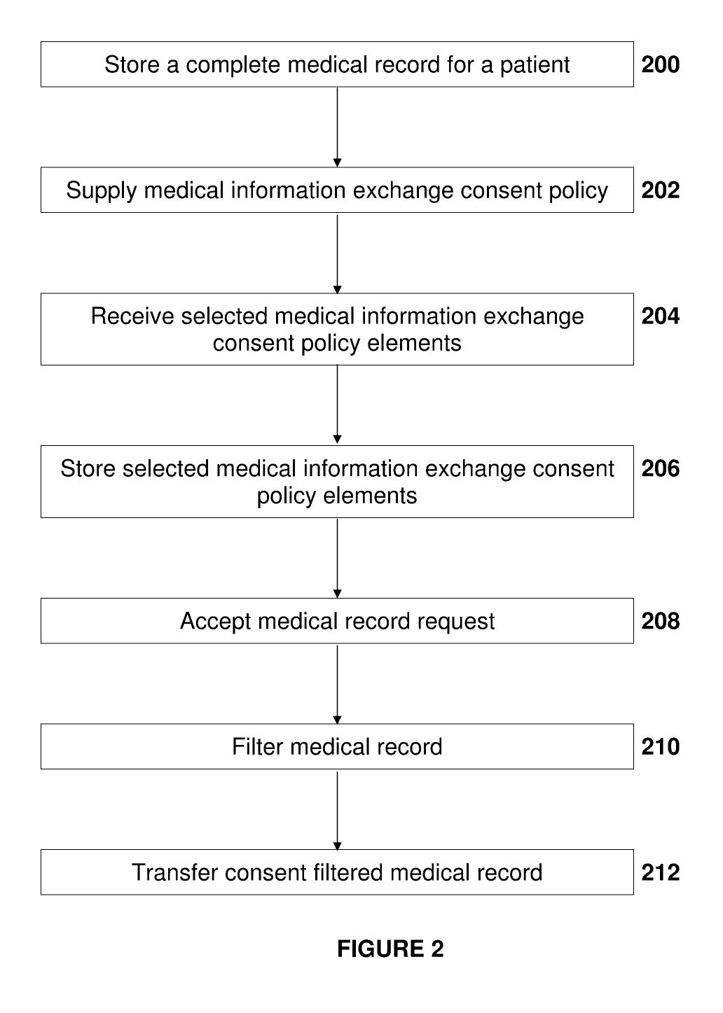

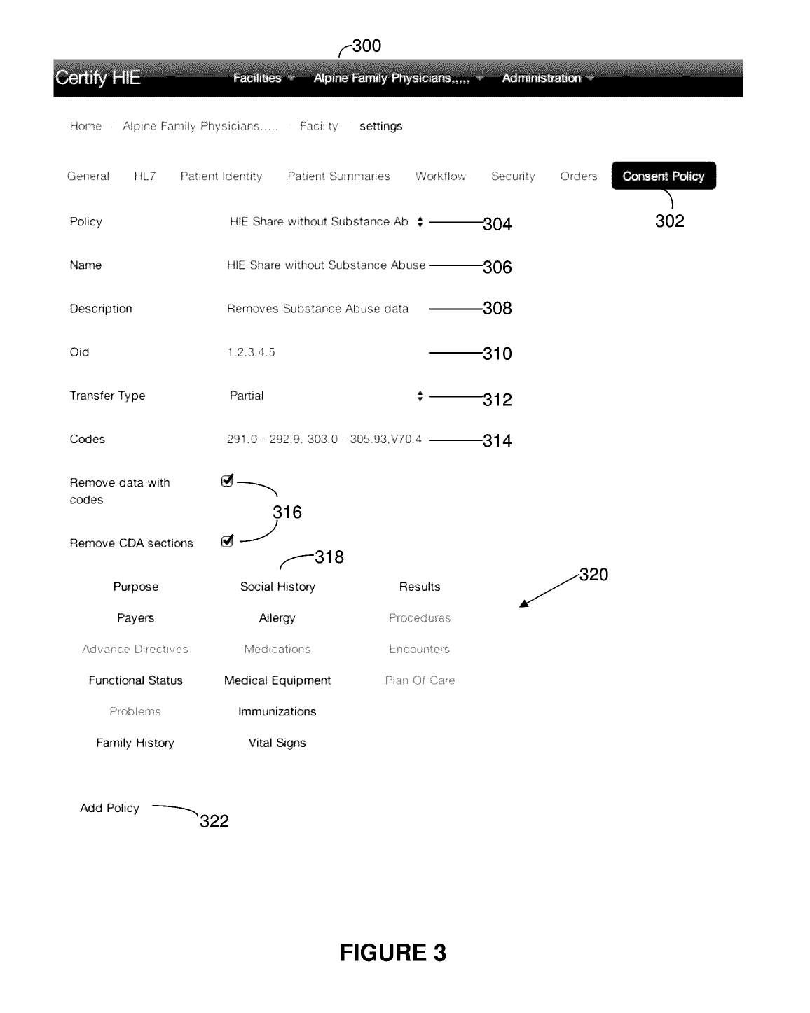

FIG. 2 illustrates processing operations of a consent policy module for an example embodiment of the invention. A complete medical record for a patient is stored 200. For example, this record may be the complete medical record from a mental health clinic. A medical information exchange consent policy is then supplied to the patient 202. An example of such a policy is discussed in connection with FIG. 3. Selected medical information exchange consent policy elements are then received 204. The selected medical information exchange consent policy elements are then stored 206. These elements may be stored in a legacy EMR system (e.g., FIG. 1 legacy clinic EMR system 108) or at an EMR appliance or apparatus 102.

Referring again to FIG. 2, subsequently, a medical record request is accepted 208. For example, the family physician may request medical records for a patient from all EMR systems in a network. The medical records are filtered 210. More particularly, the medical records are filtered in accordance with the selected medical information exchange consent policy elements to form a consent-filtered medical record. The consent-filtered medical record is then transferred 212. For example, a consent-filtered medical record may be transferred from the mental health clinic to the family physician.

FIG. 3 illustrates an exemplary medical information exchange consent policy user interface 300. The consent policy may be selected with button 302. A pull-down menu 304 may define various consent policy templates. Each template has pre-populated selected medical information exchange consent policy elements. For example, in the case of a substance abuse template, selected medical information exchange consent policy elements related to substance abuse are pre-populated.

Area 320 illustrates various selectable medical information exchange consent policy elements. In this example, the items are pre-populated for their relevance to substance abuse. Social history 318 is an example of a selectable medical information exchange consent policy element. Indicia (coloring, cross-hatching, font, etc.) may be used to indicate which elements are in force by default. The default elements may be maintained or overridden through user action. In addition to the default items, one or more additional selectable medical information exchange consent policy elements may be presented for selection.

Other features associated with the user interface 300 include a policy name, as shown with window 306. A text description of the policy may be provided, as shown with window 308. Additional characteristics of the policy, such as its age 310 may be provided. The data transfer characteristics may also be characterized, as shown with window 312. Implicated CDA codes may also be listed, as shown with window 314.

The interface 300 may also allow a user to select the removal of data for the specified codes of block 316, as shown with item 320. After the elements of user interface 300 are manipulated, the policy may be invoked through activation of button 322. Thereafter, a complete medical record will be filtered in accordance with the specified consent policy.

A user may create a policy and mark it as the default for a given clinic or set of clinics based on geography. This feature is useful for large healthcare systems that may have different laws in different states for health information exchange sharing of data. For example, a user can implement the same set of policies but mark one of those policies as the default in Georgia clinics and a different policy as the default in Florida clinics. Patients still have the ability to actively select the other policies as defined by the health care system.

The consent policy system also supports the ability to define different consent policies per clinic, if desired. This feature allows healthcare systems to rollout consent management on a regional basis.

In an embodiment of the system, the recipient does not store a received consent-filtered medical record. Rather, if the recipient requires the record again, a new request is made. This approach has the advantage that a patient can subsequently alter a consent policy and know that the new consent policy will be applied when a medical professional accesses medical information. This approach is also advantageous because it reduces data proliferation.

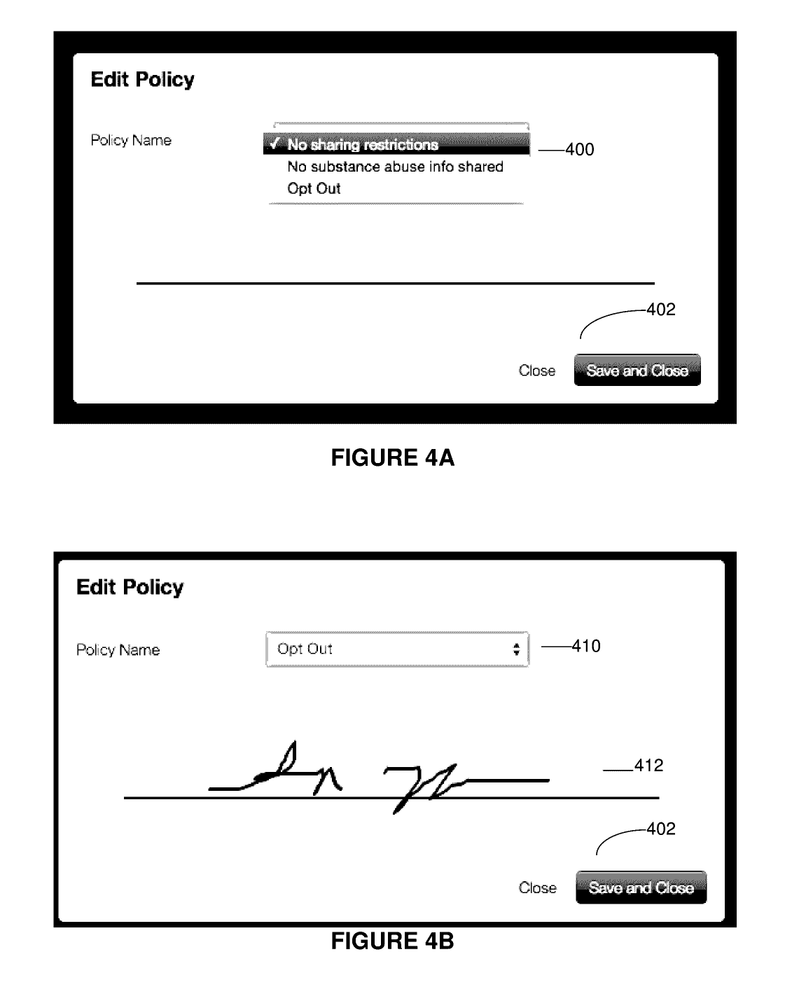

FIGS. 4A and 4B illustrate a patient policy selection interface for an example embodiment of the invention. In an example embodiment operational on a touch screen device, a patient selects a consent policy. Referring to FIG. 4A, in the example, a patient may select an option of “No sharing restrictions” (indicating all PHI may be shared), “No substance abuse info shared” (indicating all PHI except for PHI related to substance abuse may be shared), or “Opt Out” (indicating no PHI may be shared) 400. Referring to FIG. 4B, after selecting a policy 410, the patient provides a signature 412. Selection of a “Save and Close” option 402 causes the patient's selection to be recorded so that any requests for the patient's PHI are processed in a manner consistent with the selected policy.

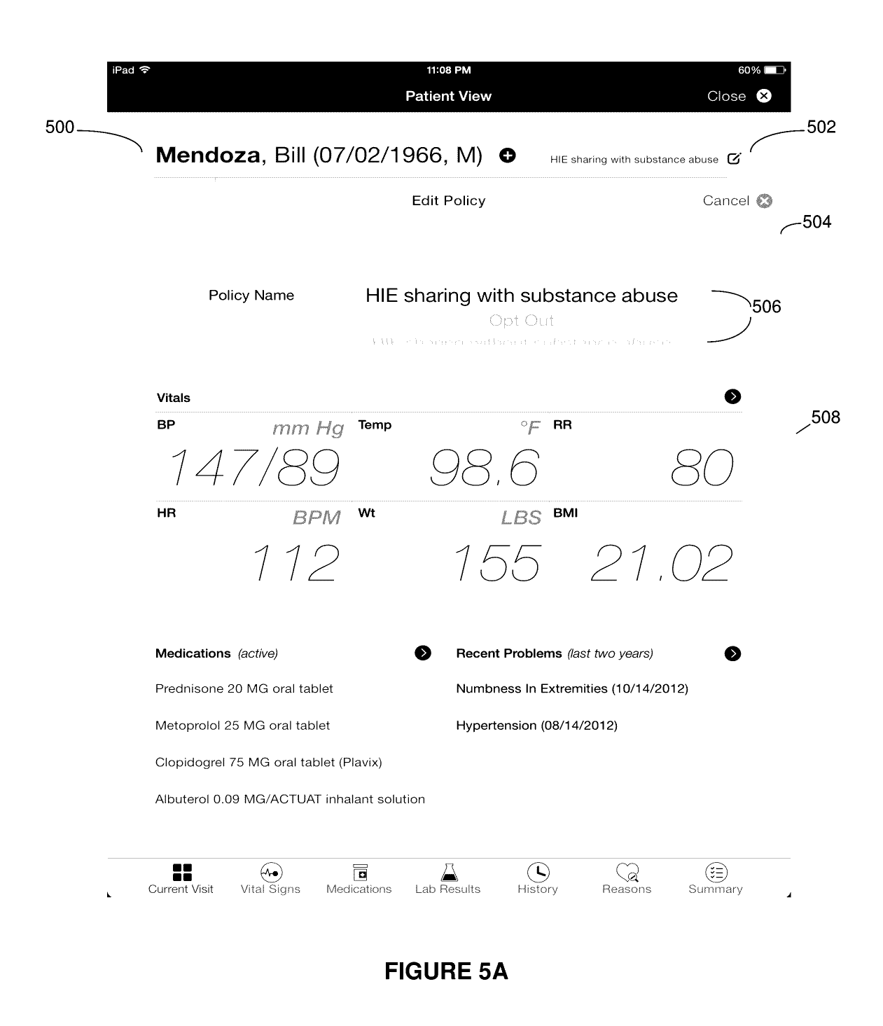

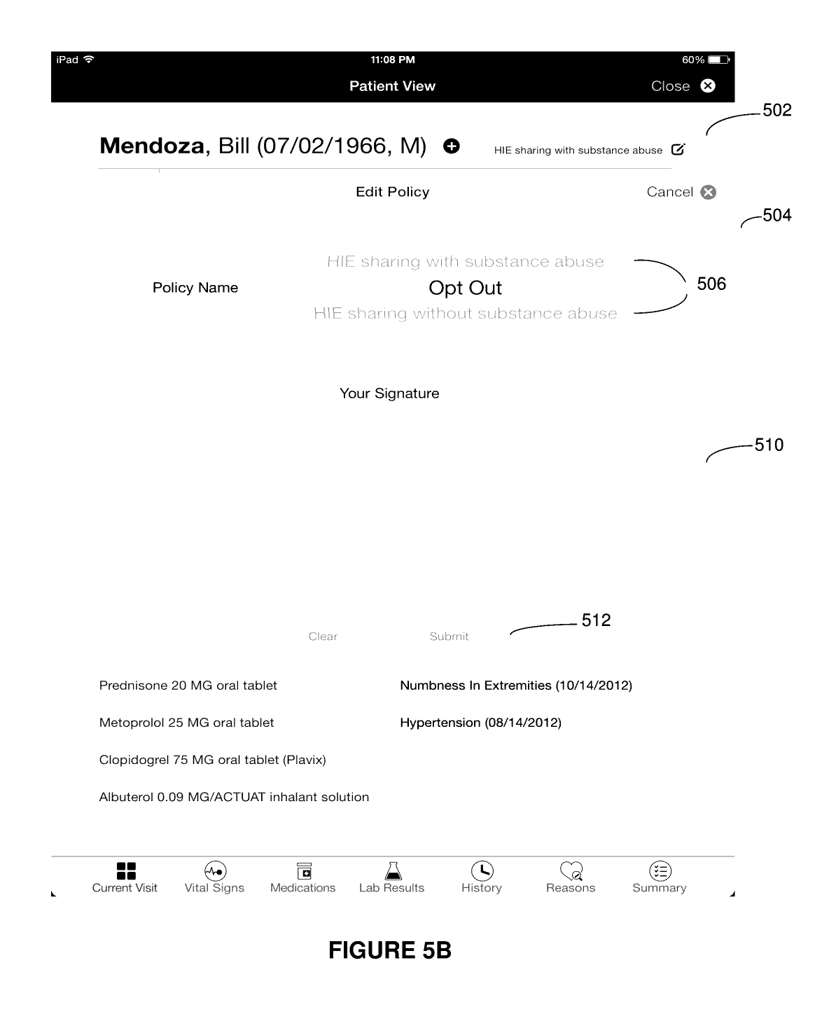

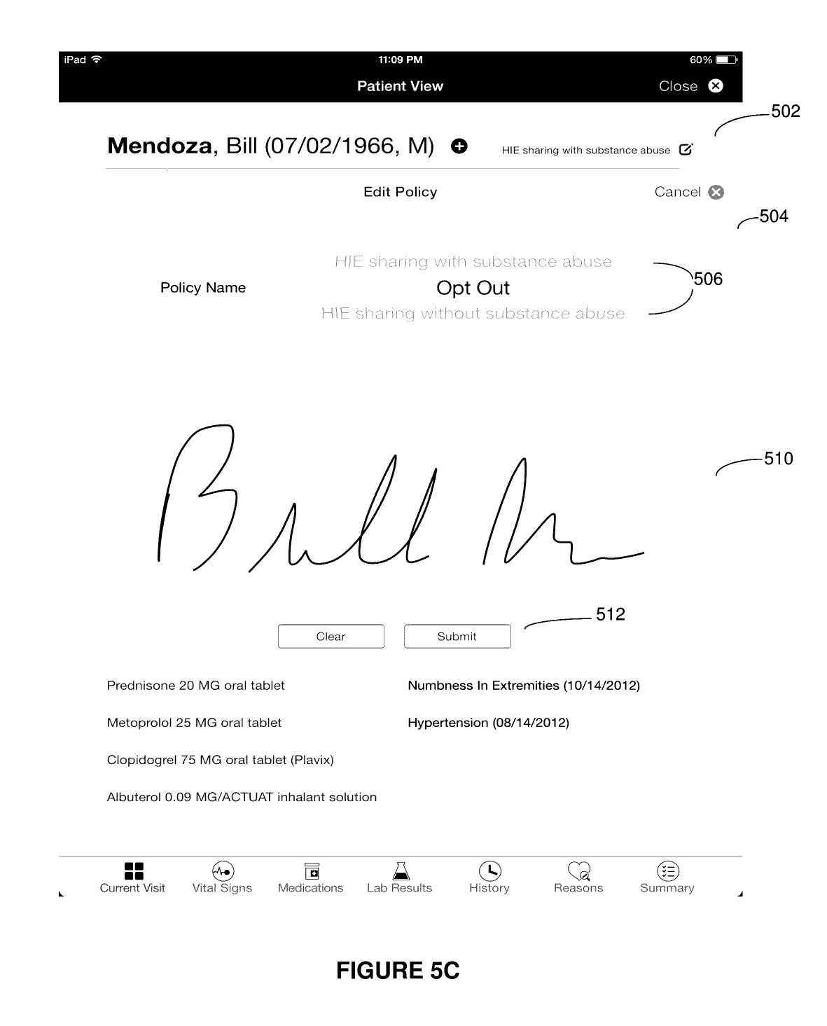

FIGS. 5A-5C illustrate a patient policy selection interface for a patient view embodiment of the invention. Referring to FIG. 5A, a touch screen application that presents patient identifying data 500 and patient clinical data 508 to a healthcare provider comprises a currently selected patient consent policy 502. During a patient consultation, the healthcare provider may ask the patient whether he wants to change the currently selected consent policy. An “edit policy” popup 504 allows the patient to select a different policy 506.

Referring to FIG. 5B, after selecting a new policy, a signature box is presented 510 so the patient can provide a signature affirming his consent to the new policy. Referring to FIG. 5C, after providing a signature 510, the patient selects a submit option 512 so the new policy selection is recorded in the patient's EMR. Any requests for the patient's PHI are then processed in a manner consistent with the newly selected policy.

The disclosed decentralized consent policy management technique avoids the problem of delivering a full medical record along with a consent policy and the concomitant hope that the recipient applies the consent policy. Rather, the recipient only receives the information that the patient has specified the recipient can receive. Because the policy is selected and applied locally, the health care provider sees only the PHI the patient has agreed to share. Accordingly, there is no opportunity for the recipient to misuse full medical record information.

While certain embodiments of the disclosed consent policy management system and method are described in detail above, the scope of the invention is not to be considered limited by such disclosure, and modifications are possible without departing from the spirit of the invention as evidenced by the claims. For example, elements of the user interface and screen layouts may be varied and fall within the scope of the claimed invention. Various aspects of user interactions and presentation of data may be varied and fall within the scope of the claimed invention. Policy types and options may be varied and fall within the scope of the claimed invention. One skilled in the art would recognize that such modifications are possible without departing from the scope of the claimed invention.

What is claimed is:

1. A computerized method for managing patient consent comprising:
(a) receiving at a computerized device a patient selection of a patient consent policy;
(b) storing identifying data for said patient and said patient consent policy at an electronic medical record apparatus;
(c) receiving at said electronic medical record apparatus a request for a medical record for said patient from an electronic medical record system;
(d) retrieving by said electronic medical record apparatus from said electronic medical record system said medical record;
(e) applying at said electronic medical record apparatus said patient consent policy to said medical record to filter data from said medical record consistent with said patient consent policy; and
(f) displaying at said computerized device said filtered medical record.

2. The computerized method of claim 1 wherein said patient consent policy is identified by name.

3. The computerized method of claim 1 wherein said patient consent policy comprises clinical document architecture codes.

4. The computerized method of claim 3 wherein said clinical document architecture codes identify data to be filtered from said medical record.

5. The computerized method of claim 3 wherein said clinical document architecture codes identify sections of said medical record to be filtered.

6. The computerized method of claim 1 further comprising receiving at said computerized device following selection of said patient consent policy said patient's signature.

7. The computerized method of claim 1 further comprising:
(g) receiving at said computerized device said patient selection of a different patient consent policy;
(h) storing said identifying data for said patient and said different patient consent policy at said electronic medical record apparatus; and
(i) applying at said electronic medical record apparatus said different patient consent policy to additional medical record requests for said patient.

8. An electronic medical record apparatus, comprising: a medical information exchange consent policy module including instructions executed by a processor to:
(a) display to a patient a medical information exchange consent policy interface with a menu of medical information exchange consent policies;
(b) receive from said patient a selected medical information exchange consent policy;
(c) receive a medical record request for said patient;
(d) apply to said medical record for said patient said selected medical information exchange consent policy to form a consent-filtered medical record; and
(e) transfer said consent-filtered medical record to a computerized device for display.

9. The electronic medical record apparatus of claim 8 wherein said medical information exchange consent policy is identified by name.

10. The electronic medical record apparatus of claim 8 wherein said medical information exchange consent policy comprises clinical document architecture codes.

11. The electronic medical record apparatus of claim 10 wherein said clinical document architecture codes identify data to be filtered from said medical record.

12. The electronic medical record apparatus of claim 10 wherein said clinical document architecture codes identify document sections to be filtered from said medical record.

13. The electronic medical record apparatus of claim 8 further comprising an instruction to receive said patient's signature following said instruction to receive from said patient a selected medical information exchange consent policy.

14. The electronic medical record apparatus of claim 8 further comprising instructions executed by said processor to:
(f) receive from said patient a selection of a different medical information exchange consent policy; and
(g) apply at said electronic medical record apparatus said different patient consent policy to an additional medical record request for said patient.

15. A computerized method for managing patient consent policies comprising:
(a) receiving at a computer patient consent policy data comprising for each of a plurality of patient consent policies:
(1) a name for said patient consent policy; and
(2) at least one clinical document architecture code for filtering medical records;
(b) storing at said computer said patient consent policy data;
(c) receiving at said computer patient policy selections comprising for each of a plurality of patients:
(1) identifying data for said patient; and
(2) a selection of one of said plurality of patient consent policies;
(d) receiving at said computer a request for a medical record for one of said plurality of patients;
(e) apply at said computer to said medical record for said patient said patient's selection of said plurality of patient consent policies to create a consent-filtered medical record; and
(f) transfer for display at a computerized device said consent-filtered medical record.

16. The computerized method of claim 15 wherein receiving at a computer patient consent policy data further comprises receiving at least one indicator selected from the group consisting of:
removing data from said medical record with said clinical architecture document code and removing clinical document architecture sections with said clinical architecture document code.

17. The computerized method of claim 15 wherein receiving at a computer patient consent policy data further comprises receiving a description of said patient consent policy.

18. The computerized method of claim 15 wherein said plurality of patient consent policies are selected from the group consisting of:
no sharing restrictions, no sharing of substance abuse information, and no sharing of any information.

19. The computerized method of claim 15 wherein receiving at said computer patient policy selections comprises receiving a patient signature for each patient policy selection.

20. The computerized method of claim 15 further comprising receiving from at least one of said plurality of patients a request to change said selection of one of said plurality of patient consent policies.
